(19) United States
(12) Patent Application Publication
(10) Pub. No.: US 2026/0313624 A1
(43) Pub. Date: Oct. 8, 2026

(54) DEVICES, APPARATUSES, AND COMPUTER READABLE MEDIA FOR RESOURCE ASSIGNMENT

(71) Applicant: Nokia Technologies Oy, Espoo (FI)

(72) Inventors: Jie Gao, Binjiang District Hangzhou (CN); Claudio Rosa, Randers NV (DK); Erika Portela Lopes De Almeida, Aalborg (DK); Nhat-Quang Nhan, Reims (FR); Jing Yuan Sun, 6 Hepingli Dongcheng District (CN); Youngsoo Yuk, Seoul (KR); Roberto Maldonado, Aalborg (DK)

(73) Assignee: Nokia Technologies Oy, Espoo (FI)

(21) Appl. No.: 19/483,292

(22) PCT Filed: May 11, 2023
(86) PCT No.: PCT/CN2023/093392

§ 371 Date: Nov. 11, 2025

(51) Int. Cl. H04W 72/0453; H04L 5/00; H04L 5/14; H04W 72/0457

(52) U.S. Cl. CPC H04W 72/0453; H04L 5/0039; H04L 5/0041; H04L 5/14; H04W 72/0457

(57) ABSTRACT

Disclosed are devices, methods, apparatuses, and computer readable media for resource assignment. An example apparatus for a terminal device may include at least one processor and at least one memory. The at least one memory may store instructions that, when executed by the at least one processor, may cause the terminal device at least to: receive from a network device serving the terminal device, a configuration of sub-band full duplex comprising non-contiguous downlink sub-bands, a configuration of a non-sub-band full duplex comprising a contiguous downlink band, and a frequency domain resource assignment for downlink; determine whether the frequency domain resource assignment is for the sub-band full duplex or for the non-sub-band full duplex; if the frequency domain resource assignment is for the sub-band full duplex, apply as a reference point of physical resource blocks for the frequency domain resource assignment, a first physical resource block of a first downlink sub-band of the non-contiguous downlink sub-bands; else if the frequency domain resource assignment is for the non-sub-band full duplex, apply as a reference point of physical resource blocks for the frequency domain resource assignment, a second physical resource block of the contiguous downlink band that is different from the first physical resource block; and determine physical resource blocks of the frequency domain resource assignment by using the applied reference point and receive data in the determined physical resource blocks.

### TECHNICAL FIELD

Various example embodiments relate to devices, methods, apparatuses, and computer readable media for resource assignment.

### BACKGROUND

Simultaneous downlink (DL) and uplink (UL) transmission on different physical resource blocks (PRBs)/sub-bands within an unpaired wideband new radio (NR) cell is allowed, which may be referred to as sub-band full duplex (SBFD). Such duplexing scheme may also be referred to as cross division duplexing (xDD) scheme or full or flexible division duplexing (FDU). In a case where the SBFD is configured with an UL sub-band in the middle of two DL sub-bands, which may be referred to as downlink uplink downlink (DUD) configuration, in some scenarios, discontinuity problems would occur. For example, in case of bandwidth part (BWP) and frequency domain resource assignment or allocation (FDRA) indication, relevant DL channels, signal configurations need to consider the discontinuity. Further, for example, both the measurement configuration and measurement reporting of channel status information reference signal (CSI-RS) require continuous resource block (RB) configuration, FDRA resource allocation type 1 requires contiguous RB configurations within the BWP, FDRA resource allocation type 0 allocations on resource block groups (RBGs) on sub-band edges may have inconsistent problems, and so on.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus may include at least one processor and at least one memory. The at least one memory may store instructions that, when executed by the at least one processor, may cause the terminal device at least to: receive from a network device serving the terminal device, a configuration of sub-band full duplex comprising non-contiguous downlink sub-bands, a configuration of a non-sub-band full duplex comprising a contiguous downlink band, and a frequency domain resource assignment for downlink; determine whether the frequency domain resource assignment is for the sub-band full duplex or for the non-sub-band full duplex; if the frequency domain resource assignment is for the sub-band full duplex, apply as a reference point of physical resource blocks for the frequency domain resource assignment, a first physical resource block of a first downlink sub-band of the non-contiguous downlink sub-bands; else if the frequency domain resource assignment is for the non-sub-band full duplex, apply as a reference point of physical resource blocks for the frequency domain resource assignment, a second physical resource block of the contiguous downlink band that is different from the first physical resource block; and determine physical resource blocks of the frequency domain resource assignment by using the applied reference point and receive data in the determined physical resource blocks.

In a second aspect, disclosed is an apparatus for a network device. The apparatus may include at least one processor and at least one memory. The at least one memory may store instructions that, when executed by the at least one processor, may cause the network device at least to: transmit to a terminal device served by the network device, a configuration of sub-band full duplex comprising non-contiguous downlink sub-bands, a configuration of a non-sub-band full duplex comprising a contiguous downlink band, and a frequency domain resource assignment for downlink; determine whether the frequency domain resource assignment is for the sub-band full duplex or for the non-sub-band full duplex; if the frequency domain resource assignment is for the sub-band full duplex, apply as a reference point of physical resource blocks for the frequency domain resource assignment, a first physical resource block of a first downlink sub-band of the non-contiguous downlink sub-bands; else if the frequency domain resource assignment is for the non-sub-band full duplex, apply as a reference point of physical resource blocks for the frequency domain resource assignment, a second physical resource block of the contiguous downlink band that is different from the first physical resource block; and determine physical resource blocks of the frequency domain resource assignment by using the applied reference point and transmit data in the determined physical resource blocks.

In a third aspect, disclosed is a method performed by an apparatus for a terminal device. The method may comprise: receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink; determining whether the frequency domain resource assignment is for the sub-band full duplex or for the non-sub-band full duplex; if the frequency domain resource assignment is for the sub-band full duplex, applying as a reference point of physical resource blocks for the frequency domain resource assignment, a first physical resource block of a first downlink sub-band of the non-contiguous downlink sub-bands; else if the frequency domain resource assignment is for the non-sub-band full duplex, applying as a reference point of physical resource blocks for the frequency domain resource assignment, a second physical resource block of the contiguous downlink band that is different from the first physical resource block; and determining physical resource blocks of the frequency domain resource assignment by using the applied reference point and receiving data in the determined physical resource blocks.

In a fourth aspect, disclosed is a method performed by an apparatus for a network device. The method may comprise: transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink; determining whether the frequency domain resource assignment is for the sub-band full duplex or for the non-sub-band full duplex; if the frequency domain resource assignment is for the sub-band full duplex, applying as a reference point of physical resource blocks for the frequency domain resource assignment, a first physical resource block of a first downlink sub-band of the non-contiguous downlink sub-bands; else if the frequency domain resource assignment is for the non-sub-band full duplex, applying as a reference point of physical resource blocks for the frequency domain resource assignment, a second physical resource block of the contiguous downlink band that is different from the first physical resource block; and determining physical resource blocks of the frequency domain resource assignment by using the applied reference point and transmitting data in the determined physical resource blocks.

In a fifth aspect, disclosed is an apparatus for a terminal device. The apparatus for the terminal device may comprise: means for receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink; means for determining whether the frequency domain resource assignment is for the sub-band full duplex or for the non-sub-band full duplex; means for, if the frequency domain resource assignment is for the sub-band full duplex, applying as a reference point of physical resource blocks for the frequency domain resource assignment, a first physical resource block of a first downlink sub-band of the non-contiguous downlink sub-bands; means for, else if the frequency domain resource assignment is for the non-sub-band full duplex, applying as a reference point of physical resource blocks for the frequency domain resource assignment, a second physical resource block of the contiguous downlink band that is different from the first physical resource block; and means for determining physical resource blocks of the frequency domain resource assignment by using the applied reference point and receiving data in the determined physical resource blocks.

In a sixth aspect, disclosed is an apparatus for a network device. The apparatus for the network device may comprise: means for transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink; means for determining whether the frequency domain resource assignment is for the sub-band full duplex or for the non-sub-band full duplex; means for, if the frequency domain resource assignment is for the sub-band full duplex, applying as a reference point of physical resource blocks for the frequency domain resource assignment, a first physical resource block of a first downlink sub-band of the non-contiguous downlink sub-bands; means for, else if the frequency domain resource assignment is for the non-sub-band full duplex, applying as a reference point of physical resource blocks for the frequency domain resource assignment, a second physical resource block of the contiguous downlink band that is different from the first physical resource block; and means for determining physical resource blocks of the frequency domain resource assignment by using the applied reference point and transmitting data in the determined physical resource blocks.

In a seventh aspect, a computer readable medium is disclosed. The computer readable medium may comprise program instructions that, when executed by an apparatus for a terminal device, may cause the terminal device at least to perform: receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink; determining whether the frequency domain resource assignment is for the sub-band full duplex or for the non-sub-band full duplex; if the frequency domain resource assignment is for the sub-band full duplex, applying as a reference point of physical resource blocks for the frequency domain resource assignment, a first physical resource block of a first downlink sub-band of the non-contiguous downlink sub-bands; else if the frequency domain resource assignment is for the non-sub-band full duplex, applying as a reference point of physical resource blocks for the frequency domain resource assignment, a second physical resource block of the contiguous downlink band that is different from the first physical resource block; and determining physical resource blocks of the frequency domain resource assignment by using the applied reference point and receiving data in the determined physical resource blocks.

In an eighth aspect, a computer readable medium is disclosed. The computer readable medium may comprise program instructions that, when executed by an apparatus for a network device, cause the network device at least to perform: transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink; determining whether the frequency domain resource assignment is for the sub-band full duplex or for the non-sub-band full duplex; if the frequency domain resource assignment is for the sub-band full duplex, applying as a reference point of physical resource blocks for the frequency domain resource assignment, a first physical resource block of a first downlink sub-band of the non-contiguous downlink sub-bands; else if the frequency domain resource assignment is for the non-sub-band full duplex, applying as a reference point of physical resource blocks for the frequency domain resource assignment, a second physical resource block of the contiguous downlink band that is different from the first physical resource block; and determining physical resource blocks of the frequency domain resource assignment by using the applied reference point and transmitting data in the determined physical resource blocks.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for resource assignment according to the example embodiments of the present disclosure.

FIG. 2 shows an exemplary flow for determining the reference point according to the example embodiments of the present disclosure.

FIG. 3A shows an exemplary SBFD to which the example embodiments of the present disclosure may be implemented.

FIG. 3B shows an exemplary non-SBFD to which the example embodiments of the present disclosure may be implemented.

FIG. 4 shows an exemplary SBFD to which the example embodiments of the present disclosure may be implemented.

FIG. 5 shows an exemplary SBFD to which the example embodiments of the present disclosure may be implemented.

FIG. 6 shows a flow chart illustrating an example method 600 for resource assignment according to the example embodiments of the present disclosure.

FIG. 7 shows a flow chart illustrating an example method 700 for resource assignment according to the example embodiments of the present disclosure.

FIG. 8 shows a block diagram illustrating an example device 800 for resource assignment according to the example embodiments of the present disclosure.

FIG. 9 shows a block diagram illustrating an example device 900 for resource assignment according to the example embodiments of the present disclosure.

FIG. 10 shows a block diagram illustrating an example apparatus 1000 for resource assignment according to the example embodiments of the present disclosure.

FIG. 11 shows a block diagram illustrating an example apparatus 1100 for resource assignment according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for resource assignment. According to example embodiments of the present disclosure, in the example scenarios such as BWP and FDRA indication, CSI-RS, control resource set (CORESET), FDRA type 0, FDRA type 1, etc., problems caused by non-contiguous DL sub-bands may be solved.

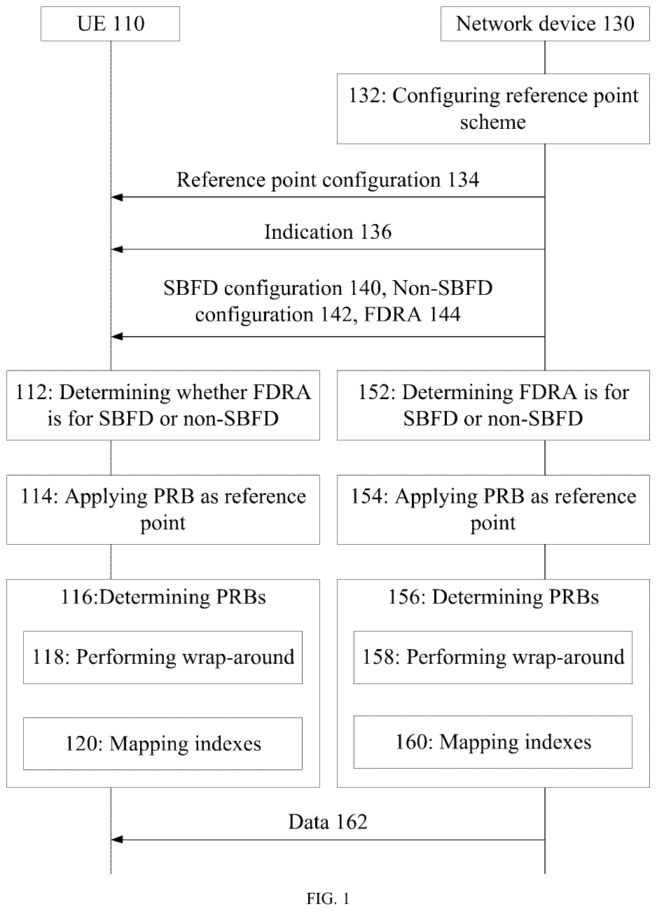

FIG. 1 shows an exemplary sequence diagram for resource assignment according to the example embodiments of the present disclosure. Referring to the FIG. 1, a user equipment (UE) 110 may represent any terminal device supporting SBFD in a wireless network. A network device 130 may represent the network side of the wireless network. The network device 130 may function as a cell serving the UE 110.

In some embodiments, the network device 130 may transmit to the UE 110 a configuration 140 of SBFD comprising non-contiguous downlink sub-bands, a configuration 142 of a non-SBFD comprising a contiguous downlink band, and a FDRA 144 for downlink. In this case, the UE 110 may perform a resource assignment according to a reference point scheme for PRBs, and the network device 130 may also perform the resource assignment according to the reference point scheme for PRBs such that the network device 130 may be aware which PRBs the UE 110 would use.

The reference point scheme may be specified in a 3rd Generation Partnership Project (3GPP) standard or specification. Alternatively, in an operation 132, the network device 130 may configure for the UE 110 a reference point scheme for PRBs and transmit to the UE 110 a reference point configuration 134 comprising the reference point scheme such that the UE 110 and the network device 130 may perform the resource assignment according to the reference point configuration 134. Alternatively or additionally, the network device 130 may transmit to the UE 110 an indication 136 allowing the UE 110 to perform the resource assignment according to the reference point scheme.

In some embodiments, the UE 110 and the network device 130 may perform the resource assignment according to the reference point scheme as below.

In an operation 112, the UE 110 may determine whether the FDRA is for the SBFD or for the non-SBFD, and then, in an operation 114, the UE 110 may apply a PRB as a reference point for the PRBs to be assigned/allocated. Correspondingly, in an operation 152, the network device 130 may determine whether the FDRA is for the SBFD or for the non-SBFD, and then, in an operation 154, the network device 130 may apply a PRB as a reference point for the PRBs to be assigned/allocated. The PRB applied as the reference point for the FDRA may be different for the SBFD than for the non-SBFD.

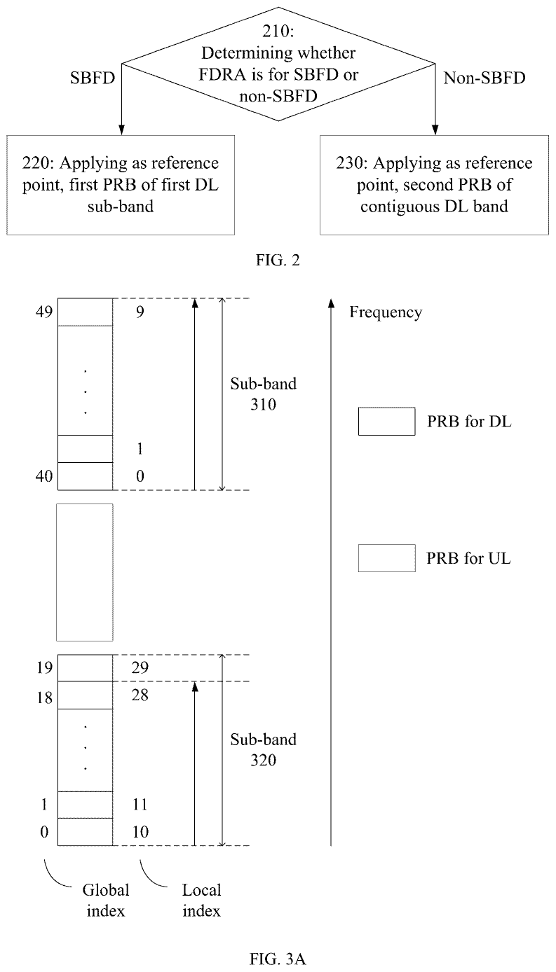

FIG. 2 shows an exemplary flow for determining the reference point according to the example embodiments of the present disclosure. The exemplary flow shown in the FIG. 2 may be performed by the UE 110 and the network device 130, respectively. For example, the operation 210 may be the operation 112 or the operation 152.

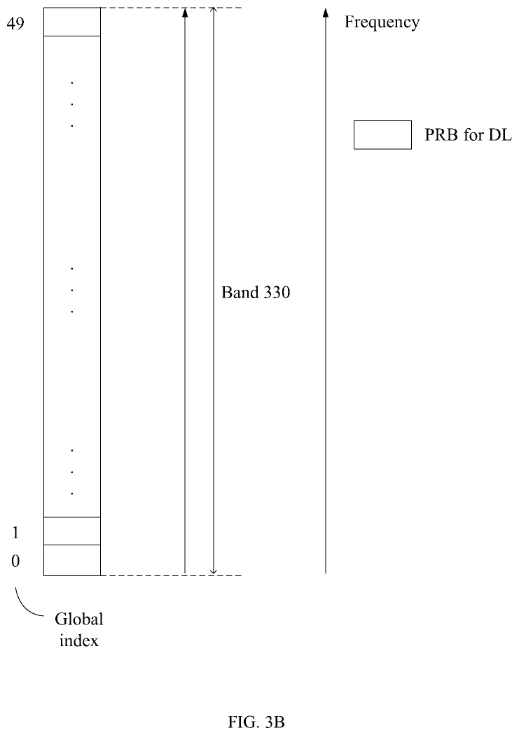

FIG. 3A shows an exemplary SBFD to which the example embodiments of the present disclosure may be implemented. The exemplary SBFD shown in the FIG. 3A is configured with an upper sub-band 310 and a lower sub-band 320 for downlink and a sub-band for uplink between the sub-band 310 and the sub-band 320. As illustrated in FIG. 3A, the downlink sub-bands 310, 320 are non-contiguous because there is at least one other sub-band therebetween (the uplink sub-band in this case). The sub-band 320, the sub-band for uplink, and the sub-band 310 may belong to a carrier band. The PRBs in the sub-band 320, the sub-band for uplink, and the sub-band 310 may have global indexing, for example, 0, 1, . . . , 49.

FIG. 3B shows an exemplary non-SBFD to which the example embodiments of the present disclosure may be implemented. The exemplary non-SBFD shown in the FIG. 3B is configured with a carrier band 330 for downlink. The PRBs in the band 330 may have global indexing, for example, 0, 1, . . . , 49.

The PRBs shown in the FIG. 3A and the FIG. 3B may also be termed as common resource blocks (CRBs), the indices of which are numbered globally from one end to the other end of the carrier band, e.g., 0, 1, . . . .

Referring back to the FIG. 2, if the FDRA is for the SBFD (“SBFD” mode of the operation 210), e.g. in SBFD slots/symbols, the UE 110 and the network device 130 may perform an operation 220 as the operation 114 and the operation 154, respectively. In the operation 220, the UE 110 and the network device 130 may apply as the reference point of PRBs for the FDRA, a first PRB of a first downlink sub-band of the non-contiguous downlink sub-bands. The FIG. 3A shows the scenario that the configuration 140 of SBFD comprises non-contiguous downlink sub-bands which are the sub-band 310 and the sub-band 320. In the operation 220, for example, one of the sub-band 310 and the sub-band 320 may be the first downlink sub-band, and a PRB of the first downlink sub-band may be the first PRB which is applied as the reference point.

In some embodiments, the first downlink sub-band may be the upper downlink sub-band, of the non-contiguous downlink sub-bands, e.g. the sub-band 310 shown in the FIG. 3A. In some embodiments, the first PRB may be the PRB with the smallest index in the first downlink sub-band. For example, in the FIG. 3A, the PRB with global index 40 is the PRB with the smallest index in the sub-band 310, and the PRB with global index 40 may be applied as the reference point. From another perspective, the PRB having the smallest index that is subsequent to the greatest PRB index of the uplink sub-band in an increasing index order is selected as the reference point.

Referring back to the FIG. 2, if the FDRA is for the non-SBFD (“Non-SBFD” mode of the operation 210), e.g. in non-SBFD slots/symbols, the UE 110 and the network device 130 may perform an operation 230 as the operation 114 and the operation 154, respectively. In the operation 220, the UE 110 and the network device 130 may apply as a reference point of PRBs for the FDRA, a second PRB of the contiguous downlink band that is different from the first PRB. The FIG. 3B shows the scenario that the configuration 142 of non-SBFD comprises a contiguous downlink band which is the band 330. In the operation 230, for example, a PRB of the band 330 may be the second PRB which is applied as the reference point. For example, in the FIG. 3B, the PRB with the smallest index, e.g. 0, in the band 330 may be applied as the reference point.

Assuming that the band shown in the FIG. 3A and the band 330 shown in the FIG. 3B are identical, the first PRB applied as the reference point in the operation 220, e.g. the PRB with global index 40 shown in the FIG. 3A is different from the second PRB applied as the reference point in the operation 230, e.g. the PRB with global index 0 shown in the FIG. 3B.

In a case where the UE 110 is also configured with a SBFD comprising a contiguous downlink sub-band, e.g. the band comprises a sub-band for uplink and a sub-band for downlink and is without non-contiguous downlink sub-bands, the UE 110 and the network device 130 may treat such case as the non-SBFD comprising a contiguous downlink band. For example, the UE 110 and the network device 130 may apply as a reference point of PRBs for the FDRA, a PRB of the contiguous downlink sub-band, e.g. the PRB with smallest index in the downlink sub-band, which is different from the first PRB.

Referring back to the FIG. 1, in an operation 116, the UE 110 may determine PRBs of the FDRA by using the applied reference point, and in an operation 156, the network device 130 may determine PRBs of the FDRA by using the applied reference point. In some embodiments, the UE 110 may be configured by the network device 130 with at least one of the following: CSI-RS, CORESET, FDRA type 0, or FDRA type 1. If e.g. the CSI-RS is assigned with N PRBs (N is integer), in the operation 116 and the operation 156, the UE 110 and the network device 130 may determine N PRBs by using the applied reference point as the starting PRB, respectively.

Referring to the FIG. 3A, if the PRB with global index 40 is the reference point, N PRBs starting from the PRB with global index 40 may be determined, and the determined N PRBs have local indices e.g. from 0 to N−1. In a case where, starting from the first PRB, the determined PRBs exceed the first downlink sub-band, e.g. in the FIG. 3A, the first downlink sub-band is the sub-band 310, and N is above 10, in an operation 118 and an operation 158, the UE 110 and the network device 130 may perform wrap-around to a second downlink sub-band of the non-contiguous downlink sub-bands for the determined PRBs, respectively. In this case, as is shown in the FIG. 3A, the second downlink sub-band may be the sub-band 320, and the PRBs in the sub-band 320 may be determined. For example, if N is 29, the wrap-around may be from the PRB with the smallest index in the sub-band 320, and thus 19 PRBs with global indices 0 to 18 in the sub-band 320 may be determined. The determined 29 PRBs are PRBs with global indices 40 to 49 and 0 to 18 and have local indices 0 to 28. Wrap-around thus means continuing PRB selection for the FDRA from a lower sub-band (having smaller PRB indices). From the indexing continuity point of view, the wrap-around may then be seen as a way to make the sub-bands 310 and 320 virtually contiguous, thus enabling the use of a single reference point for the FDRA.

Referring to the FIG. 3B, if the PRB with global index 0 is the reference point, N PRBs starting from the PRB with global index 0 may be determined. In this case, no wrap-around is used as it is unnecessary.

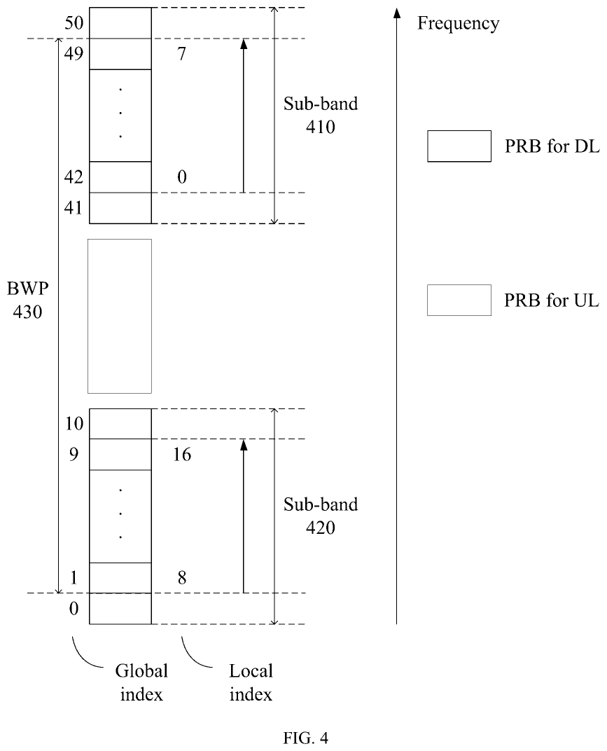

FIG. 4 shows an exemplary SBFD to which the example embodiments of the present disclosure may be implemented. The exemplary SBFD shown in the FIG. 4 is configured with an upper sub-band 410 and a lower sub-band 420 for downlink and a sub-band for uplink between the sub-band 410 and the sub-band 420. The sub-band 420, the sub-band for uplink, and the sub-band 410 may belong to a carrier band. The PRBs in the sub-band 420, the sub-band for uplink, and the sub-band 410 may have global indexing, for example, 0, 1, . . . , 50.

The FIG. 4 further shows a scenario that a BWP 430 is configured for the UE 110 and the BWP 430 partly comprises the non-contiguous downlink sub-bands 410 and 420. As is shown in the FIG. 4, the BWP 430 includes PRBs with global indices 1 to 10 in the sub-band 420 and PRBs with global indices 41 to 49 in the sub-band 410. If e.g. the CORESET is assigned with N PRBs, a PRB in both the upper sub-band 410 and the BWP 430 may be applied as the reference point. As is shown in the FIG. 4, the reference point is not limited to the PRB with the smallest index in the sub-band, for example, the PRB with global index 42 may be the first PRB and be applied as the reference point.

In the example embodiments implemented to the exemplary scenario shown in the FIG. 4, in the operation 118 and the operation 158, the UE 110 and the network device 130 may perform the wrap-around for the determined PRBs to the sub-band 420 (the second downlink sub-band in the FIG. 4), respectively, if, starting from the first PRB, the determined PRBs exceed the BWP 430.

In this case, as is shown in the FIG. 4, the PRBs in the sub-band 420 may be determined. For example, if N is 17, the wrap-around may be from the PRB with the smallest index in both the sub-band 420 and the BWP 430, and thus 9 PRBs with global indices 1 to 9 in the sub-band 420 may be determined. The determined 17 PRBs are PRBs with global indices 42 to 49 and 1 to 9 and have local indices 0 to 16.

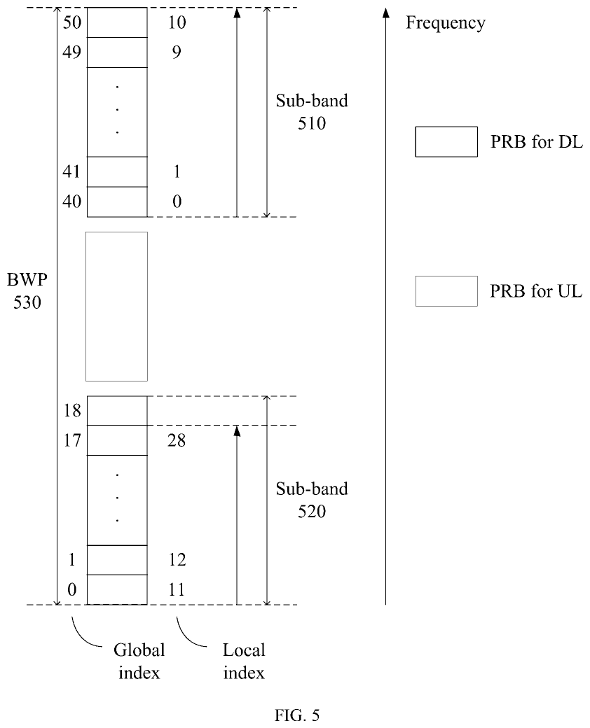

FIG. 5 shows an exemplary SBFD to which the example embodiments of the present disclosure may be implemented. The exemplary SBFD shown in the FIG. 5 is configured with an upper sub-band 510 and a lower sub-band 520 for downlink and a sub-band for uplink between the sub-band 510 and the sub-band 520. The sub-band 520, the sub-band for uplink, and the sub-band 510 may belong to a carrier band. The PRBs in the sub-band 520, the sub-band for uplink, and the sub-band 510 may have global indexing, for example, 0, 1, . . . , 50.

The FIG. 5 further shows a scenario that a BWP 530 is configured for the UE 110 and the BWP 530 comprises the non-contiguous downlink sub-bands 510 and 520. As is shown in the FIG. 5, the BWP 530 includes PRBs with global indices 0 to 18 in the sub-band 520 and PRBs with global indices 40 to 50 in the sub-band 510. If e.g. the FDRA type 0 or the FDRA type 1 is assigned with N PRBs, a PRB in the upper sub-band 510 may be applied as the reference point. As is shown in the FIG. 5, the PRB with the smallest index 40 in the sub-band 510 may be the first PRB and be applied as the reference point.

In the example embodiments implemented to the exemplary scenario shown in the FIG. 5, in the operation 118 and the operation 158, the UE 110 and the network device 130 may perform the wrap-around to the sub-band 520 (the second sub-band in the FIG. 5) for the determined PRBs, respectively, if, starting from the first PRB the determined PRBs exceed the BWP 530.

In this case, as is shown in the FIG. 5, the PRBs in the sub-band 520 may be determined. For example, if N is 29, the wrap-around may be from the PRB with the smallest index in the sub-band 520, and thus 18 PRBs with global indices 0 to 18 in the sub-band 520 may be determined. The determined 29 PRBs are PRBs with global indices 40 to 50 and 0 to 17 and have local indices 0 to 28.

Referring back to the FIG. 1, in an operation 120 and an operation 160, the UE 110 and the network device 130 may map indices of the determined PRBs to corresponding indices in the non-contiguous downlink sub-bands, respectively. For example, in the operation 120 and the operation 160, the local indices of the determined PRBs may be mapped to the corresponding global indices of the PRBs in the non-contiguous downlink sub-bands.

If the local indices of the determined PRBs are labelled as i, the global index of the reference point is labelled as REF, the size of the band is labelled as N^{size}, for example, in the FIG. 3A and the FIG. 3B, N^{size}=50, and the smallest global index in the band is labelled as N^{start}, then the local indices of the determined PRBs may be mapped to the corresponding global indices by mod(REF+i,N^{size})+N^{start}.

In a case where the BWP is configured, if the local indices of the determined PRBs are labelled as i, the global index of the reference point is labelled as REF, the size of the BWP is labelled as

$${N}_{B W P}^{s i z e} .$$

for example, in the FIG. 4

$${N}_{BWP}^{s \dot{t} z e} = 49$$

### and in the FIG. 5

$${N}_{BWP}^{s i z e} = 51 ,$$

and the smallest global index in the BWP is labelled as

$${N}_{BWP}^{start} ,$$

then the local indices of the determined PRBs may be mapped to the corresponding global indices by

$$mod ( REF + i , {N}_{BWP}^{size} ) + {N}_{BWP}^{start} .$$

The above example embodiments describe the operations the UE 110 and the network device 130 perform the resource assignment according to the reference point scheme. In the PRBs determined by the operations of the resource assignment, the network device 130 may transmit and the UE 110 may receive data 162.

According to the example embodiments of the present disclosure, the reference point of the starting PRB for FDRA can be compatible with BWP configuration, because when a SBFD UE switch between SBFD slots/symbols and non-SBFD slots/symbols, the reference point will be changed but the BWP range will not change. Further, CSI-RS can be configured with contiguous mode, so the CSI-RS configuration and the CSI-RS measurement reporting can be reused, even when the DL sub-bands are discontinuous. CORESET may also be configured using bitmap signaling with reference point in SBFD slots/symbols. Additionally, for type 0 FDRA, bitmap start PRB can refer to the reference PRB index and for type 1 FDRA, resource indication value (RIV) indication can refer to the reference PRB index in BWP, and the RIV will not exceed the BWP range due to wrap-around, so the FDRA can also be reused to allocate resources in non-contiguous DL sub-bands in SBFD slots/symbols for both the FDRA type 0 and the FDRA type 1. Moreover, downlink type 0 FDRA only has the issue of an RBG partially overlapping with the guard band and/or the UL sub-band at the boundary between the lower DL sub-band and UL sub-band/guard band, while this problem does not exists at the boundary between the upper DL sub-band and UL sub-band/guard band. The example embodiments of the present disclosure can simplify or avoid many of the FDRA issues on SBFD, such as FDRA type 0 RBG problems, FDRA type 1 RIV contiguous issue, transport block size (TBS) calculation issue, CSI-RS configuration contiguous issues, etc.

FIG. 6 shows a flow chart illustrating an example method 600 for resource assignment according to the example embodiments of the present disclosure. The example method 600 may be performed for example by an apparatus for a terminal device such as the UE 110 above mentioned.

Referring to the FIG. 6, the example method 600 may comprise: an operation 610 of receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink; an operation 620 of determining whether the frequency domain resource assignment is for the sub-band full duplex or for the non-sub-band full duplex; an operation 630 of if the frequency domain resource assignment is for the sub-band full duplex, applying as a reference point of physical resource blocks for the frequency domain resource assignment, a first physical resource block of a first downlink sub-band of the non-contiguous downlink sub-bands; an operation 640 of else if the frequency domain resource assignment is for the non-sub-band full duplex, applying as a reference point of physical resource blocks for the frequency domain resource assignment, a second physical resource block of the contiguous downlink band that is different from the first physical resource block; and an operation 650 of determining physical resource blocks of the frequency domain resource assignment by using the applied reference point and receiving data in the determined physical resource blocks.

Details of the operation 610 have been described in the above descriptions with respect to at least the SBFD configuration 140, the non-SBFD configuration 142 and the FDRA 144, and repetitive descriptions thereof are omitted here.

Details of the operation 620 have been described in the above descriptions with respect to at least the operation 112 and the operation 210, and repetitive descriptions thereof are omitted here.

Details of the operation 630 have been described in the above descriptions with respect to at least the operation 114, the operation 220 and the FIG. 3A, and repetitive descriptions thereof are omitted here.

Details of the operation 640 have been described in the above descriptions with respect to at least the operation 114, the operation 230 and the FIG. 3B, and repetitive descriptions thereof are omitted here.

Details of the operation 650 have been described in the above descriptions with respect to at least the operation 116, the FIG. 3A, the FIG. 3B and the data 162, and repetitive descriptions thereof are omitted here.

In some embodiments, the example method 600 may include an operation of performing wrap-around to a second downlink sub-band of the non-contiguous downlink sub-bands for the determined physical resource blocks in a case where, starting from the first physical resource block, the determined physical resource blocks exceed the first downlink sub-band. The more details have been described in the above descriptions with respect to at least the operation 118 and the FIG. 3A, and repetitive descriptions thereof are omitted here.

In some embodiments, the example method 600 may include an operation of in a case where a bandwidth part is configured for the terminal device and the bandwidth part at least partly comprises the non-contiguous downlink sub-bands, performing the wrap-around for the determined physical resource blocks if, starting from the first physical resource block, the determined physical resource blocks exceed the bandwidth part. The more details have been described in the above descriptions with respect to at least the operation 118, the FIG. 4 and the FIG. 5, and repetitive descriptions thereof are omitted here.

In some embodiments, the example method 600 may include an operation of mapping indices of the determined physical resource blocks to corresponding indices in the non-contiguous downlink sub-bands. The more details have been described in the above descriptions with respect to at least the operation 120, and repetitive descriptions thereof are omitted here.

In some embodiments, the first downlink sub-band may be the upper downlink sub-band of the non-contiguous downlink sub-bands. The more details have been described in the above descriptions with respect to at least the FIG. 3A, the FIG. 4 and the FIG. 5, and repetitive descriptions thereof are omitted here.

In some embodiments, the first physical resource block may be the physical resource block with the smallest index in the first downlink sub-band. The more details have been described in the above descriptions with respect to at least the FIG. 3A and the FIG. 5, and repetitive descriptions thereof are omitted here.

In some embodiments, the first physical resource block may be applied as the reference point according to a reference point configuration received from the network device. The more details have been described in the above descriptions with respect to at least the reference point configuration 134, and repetitive descriptions thereof are omitted here.

In some embodiments, the first physical resource block may be applied as the reference point in case of receiving from the network device an indication allowing the terminal device to apply as the reference point the first physical resource block. The more details have been described in the above descriptions with respect to at least the indication 136, and repetitive descriptions thereof are omitted here.

In some embodiments, the terminal device may be configured with at least one of the following: channel status information reference signal, control resource set, frequency domain resource assignment type 0, or frequency domain resource assignment type 1.

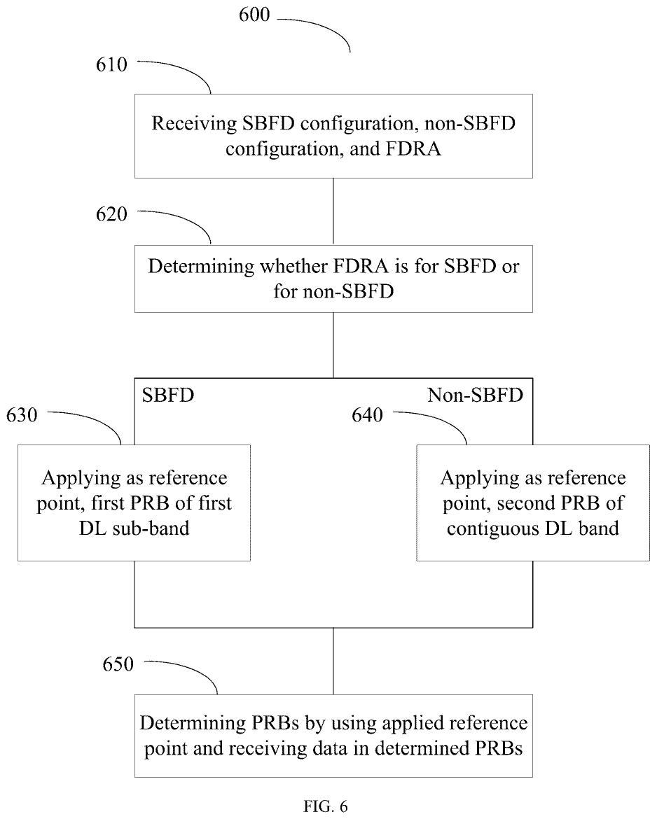

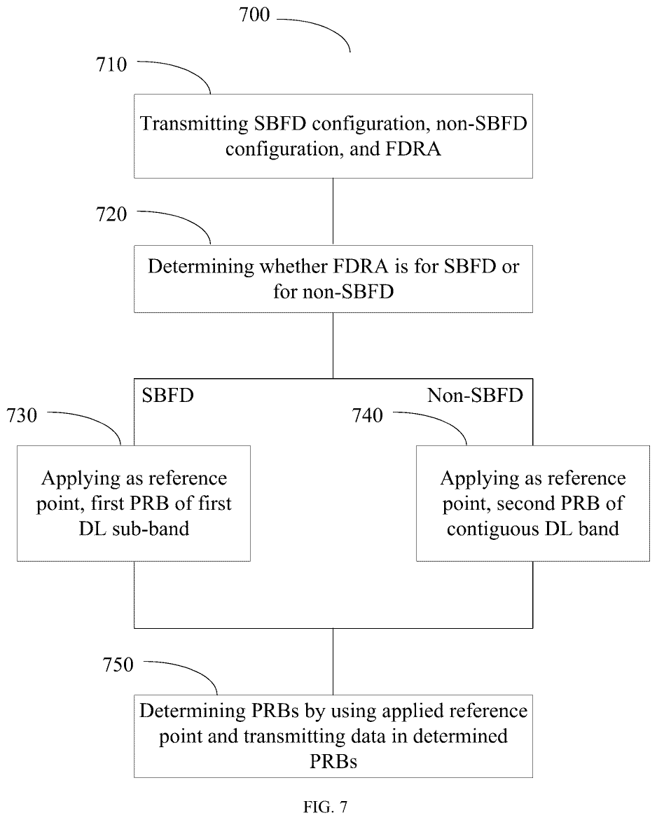

FIG. 7 shows a flow chart illustrating an example method 700 for resource assignment according to the example embodiments of the present disclosure. The example method 700 may be performed for example by a network device such as the network device 130 above mentioned.

Referring to the FIG. 7, the method 700 may comprise: an operation 710 of transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink; an operation 720 of determining whether the frequency domain resource assignment is for the sub-band full duplex or for the non-sub-band full duplex; an operation 730 of if the frequency domain resource assignment is for the sub-band full duplex, applying as a reference point of physical resource blocks for the frequency domain resource assignment, a first physical resource block of a first downlink sub-band of the non-contiguous downlink sub-bands; an operation 740 of else if the frequency domain resource assignment is for the non-sub-band full duplex, applying as a reference point of physical resource blocks for the frequency domain resource assignment, a second physical resource block of the contiguous downlink band that is different from the first physical resource block; and an operation 750 of determining physical resource blocks of the frequency domain resource assignment by using the applied reference point and transmitting data in the determined physical resource blocks.

Details of the operation 710 have been described in the above descriptions with respect to at least the SBFD configuration 140, the non-SBFD configuration 142 and the FDRA 144, and repetitive descriptions thereof are omitted here.

Details of the operation 720 have been described in the above descriptions with respect to at least the operation 152 and the operation 210, and repetitive descriptions thereof are omitted here.

Details of the operation 730 have been described in the above descriptions with respect to at least the operation 154, the operation 220 and the FIG. 3A, and repetitive descriptions thereof are omitted here.

Details of the operation 740 have been described in the above descriptions with respect to at least the operation 154, the operation 230 and the FIG. 3B, and repetitive descriptions thereof are omitted here.

Details of the operation 750 have been described in the above descriptions with respect to at least the operation 156, the FIG. 3A, the FIG. 3B and the data 162, and repetitive descriptions thereof are omitted here.

In some embodiments, the example method 700 may include an operation of performing wrap-around to a second downlink sub-band of the non-contiguous downlink sub-bands for the determined physical resource blocks in a case where, starting from the first physical resource block, the determined physical resource blocks exceed the first downlink sub-band. The more details have been described in the above descriptions with respect to at least the operation 158 and the FIG. 3A, and repetitive descriptions thereof are omitted here.

In some embodiments, the example method 700 may include an operation of in a case where a bandwidth part may be configured for the terminal device and the bandwidth part at least partly comprises the non-contiguous downlink sub-bands, performing the wrap-around for the determined physical resource blocks if, starting from the first physical resource block, the determined physical resource blocks exceed the bandwidth part. The more details have been described in the above descriptions with respect to at least the operation 158, the FIG. 4 and the FIG. 5, and repetitive descriptions thereof are omitted here.

In some embodiments, the example method 700 may include an operation of mapping indices of the determined physical resource blocks to corresponding indices in the non-contiguous downlink sub-bands. The more details have been described in the above descriptions with respect to at least the operation 160, and repetitive descriptions thereof are omitted here.

In some embodiments, the first downlink sub-band may be the upper downlink sub-band of the non-contiguous downlink sub-bands. The more details have been described in the above descriptions with respect to at least the FIG. 3A, the FIG. 4 and the FIG. 5, and repetitive descriptions thereof are omitted here.

In some embodiments, the first physical resource block may be the physical resource block with the smallest index in the first downlink sub-band. The more details have been described in the above descriptions with respect to at least the FIG. 3A and the FIG. 5, and repetitive descriptions thereof are omitted here.

In some embodiments, the example method 700 may include an operation of transmitting to the terminal device, a reference point configuration, according to which the first physical resource block may be applied as the reference point. The more details have been described in the above descriptions with respect to at least the operation 132 and the reference point configuration 134, and repetitive descriptions thereof are omitted here.

In some embodiments, the example method 700 may include an operation of transmitting to the terminal device, an indication allowing the terminal device to apply as the reference point the first physical resource block.

In some embodiments, the example method 700 may include an operation of configuring for the terminal device at least one of the following: channel status information reference signal, control resource set, frequency domain resource assignment type 0, or frequency domain resource assignment type 1.

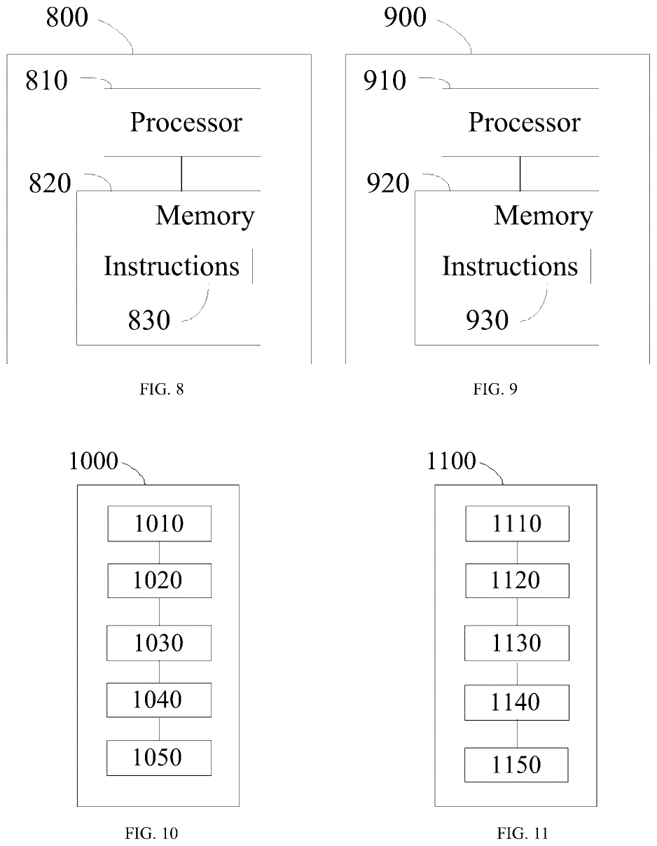

FIG. 8 shows a block diagram illustrating an example device 800 for resource assignment according to the example embodiments of the present disclosure. The device, for example, may be at least part of an apparatus for a terminal device such as the UE 110 in the above examples.

As shown in the FIG. 8, the example device 800 may include at least one processor 810 and at least one memory 820 that may store instructions 830. The instructions 830, when executed by the at least one processor 810, may cause the device 800 at least to perform the example method 600 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 800.

FIG. 9 shows a block diagram illustrating an example device 900 for resource assignment according to the example embodiments of the present disclosure. The device, for example, may be at least part of an apparatus for a network device such as the network device 130 in the above examples.

As shown in the FIG. 9, the example device 900 may include at least one processor 910 and at least one memory 920 that may store instructions 930. The instructions 930, when executed by the at least one processor 910, may cause the device 900 at least to perform the example method 700 described above.

In various example embodiments, the at least one processor 910 in the example device 900 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 910 may also include at least one other circuitry or element not shown in the FIG. 9.

In various example embodiments, the at least one memory 920 in the example device 900 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 920 may include, but are not limited to, an electric, a magnetic, an optical, an electromagnetic, an infrared, or a semiconductor system, apparatus, or device or any combination of the above.

Further, in various example embodiments, the example device 900 may also include at least one other circuitry, element, and interface, for example at least one I/O interface, at least one antenna element, and the like.

In various example embodiments, the circuitries, parts, elements, and interfaces in the example device 900, including the at least one processor 910 and the at least one memory 920, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 130 is not limited to the above example device 900.

FIG. 10 shows a block diagram illustrating an example apparatus 1000 for resource assignment according to the example embodiments of the present disclosure. The apparatus, for example, may be at least part of a terminal device such as the UE 110 in the above examples.

As shown in the FIG. 10, the example apparatus 1000 may comprise: means 1010 for receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink; means 1020 for determining whether the frequency domain resource assignment is for the sub-band full duplex or for the non-sub-band full duplex; means 1030 for, if the frequency domain resource assignment is for the sub-band full duplex, applying as a reference point of physical resource blocks for the frequency domain resource assignment, a first physical resource block of a first downlink sub-band of the non-contiguous downlink sub-bands; means 1040 for, else if the frequency domain resource assignment is for the non-sub-band full duplex, applying as a reference point of physical resource blocks for the frequency domain resource assignment, a second physical resource block of the contiguous downlink band that is different from the first physical resource block; and means 1050 for determining physical resource blocks of the frequency domain resource assignment by using the applied reference point and receiving data in the determined physical resource blocks.

In some embodiments, the apparatus 1000 may comprise: means for performing wrap-around to a second downlink sub-band of the non-contiguous downlink sub-bands for the determined physical resource blocks in a case where, starting from the first physical resource block, the determined physical resource blocks exceed the first downlink sub-band.

In some embodiments, the apparatus 1000 may comprise: means for, in a case where a bandwidth part is configured for the terminal device and the bandwidth part at least partly comprises the non-contiguous downlink sub-bands, performing the wrap-around for the determined physical resource blocks if, starting from the first physical resource block, the determined physical resource blocks exceed the bandwidth part.

In some embodiments, the apparatus 1000 may comprise: means for mapping indices of the determined physical resource blocks to corresponding indices in the non-contiguous downlink sub-bands.

In some embodiments, the first downlink sub-band may be the upper downlink sub-band of the non-contiguous downlink sub-bands.

In some embodiments, the first physical resource block may be the physical resource block with the smallest index in the first downlink sub-band.

In some embodiments, the first physical resource block may be applied as the reference point according to a reference point configuration received from the network device.

In some embodiments, the first physical resource block may be applied as the reference point in case of receiving from the network device an indication allowing the terminal device to apply as the reference point the first physical resource block.

In some embodiments, the terminal device may be configured with at least one of the following: channel status information reference signal, control resource set, frequency domain resource assignment type 0, or frequency domain resource assignment type 1.

In some example embodiments, examples of means in the example apparatus 1000 may include circuitries. For example, an example of means 1010 may include a circuitry configured to perform the operation 610 of the example method 600, an example of means 1020 may include a circuitry configured to perform the operation 620 of the example method 600, an example of means 1030 may include a circuitry configured to perform the operation 630 of the example method 600, an example of means 1040 may include a circuitry configured to perform the operation 640 of the example method 600, and an example of means 1050 may include a circuitry configured to perform the operation 650 of the example method 600.

The example apparatus 1000 may further include means comprising circuitry configured to perform the example method 600. In some example embodiments, examples of means may also include software modules and any other suitable function entities.

FIG. 11 shows a block diagram illustrating an example apparatus 1100 for resource assignment according to the example embodiments of the present disclosure. The apparatus, for example, may be at least part of a network device such as the network device 130 in the above examples.

As shown in the FIG. 11, the example apparatus 1100 may comprise: means 1110 for transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink; means 1120 for determining whether the frequency domain resource assignment is for the sub-band full duplex or for the non-sub-band full duplex; means 1130 for, if the frequency domain resource assignment is for the sub-band full duplex, applying as a reference point of physical resource blocks for the frequency domain resource assignment, a first physical resource block of a first downlink sub-band of the non-contiguous downlink sub-bands; means 1140 for, else if the frequency domain resource assignment is for the non-sub-band full duplex, applying as a reference point of physical resource blocks for the frequency domain resource assignment, a second physical resource block of the contiguous downlink band that is different from the first physical resource block; and means 1150 for determining physical resource blocks of the frequency domain resource assignment by using the applied reference point and transmitting data in the determined physical resource blocks.

In some embodiments, the apparatus 1100 may comprise: means for performing wrap-around to a second downlink sub-band of the non-contiguous downlink sub-bands for the determined physical resource blocks in a case where, starting from the first physical resource block, the determined physical resource blocks exceed the first downlink sub-band.

In some embodiments, the apparatus 1100 may comprise: means for, in a case where a bandwidth part is configured for the terminal device and the bandwidth part at least partly comprises the non-contiguous downlink sub-bands, performing the wrap-around for the determined physical resource blocks if, starting from the first physical resource block, the determined physical resource blocks exceed the bandwidth part.

In some embodiments, the apparatus 1100 may comprise: means for mapping indices of the determined physical resource blocks to corresponding indices in the non-contiguous downlink sub-bands.

In some embodiments, the first downlink sub-band may be the upper downlink sub-band of the non-contiguous downlink sub-bands.

In some embodiments, the first physical resource block may be the physical resource block with the smallest index in the first downlink sub-band.

In some embodiments, the apparatus 1100 may comprise: means for transmitting to the terminal device, a reference point configuration, according to which the first physical resource block is applied as the reference point.

In some embodiments, the apparatus 1100 may comprise: means for transmitting to the terminal device, an indication allowing the terminal device to apply as the reference point the first physical resource block.

In some embodiments, the apparatus 1100 may comprise: means for configuring for the terminal device at least one of the following: channel status information reference signal, control resource set, frequency domain resource assignment type 0, or frequency domain resource assignment type 1.

In some example embodiments, examples of means in the example apparatus 1100 may include circuitries. For example, an example of means 1110 may include a circuitry configured to perform the operation 710 of the example method 700, an example of means 1120 may include a circuitry configured to perform the operation 720 of the example method 700, an example of means 1130 may include a circuitry configured to perform the operation 730 of the example method 700, an example of means 1140 may include a circuitry configured to perform the operation 740 of the example method 700, and an example of means 1150 may include a circuitry configured to perform the operation 750 of the example method 700.

The example apparatus 1100 may further include means comprising circuitry configured to perform the example method 700. In some example embodiments, examples of means may also include software modules and any other suitable function entities.

The example embodiments of the present disclosure also provide a computer readable medium comprising program instructions that, when executed by an apparatus for a terminal device such as the UE 110 in the above examples, may cause the terminal device at least to: receive from a network device serving the terminal device, a configuration of sub-band full duplex comprising non-contiguous downlink sub-bands, a configuration of a non-sub-band full duplex comprising a contiguous downlink band, and a frequency domain resource assignment for downlink; determine whether the frequency domain resource assignment is for the sub-band full duplex or for the non-sub-band full duplex; if the frequency domain resource assignment is for the sub-band full duplex, apply as a reference point of physical resource blocks for the frequency domain resource assignment, a first physical resource block of a first downlink sub-band of the non-contiguous downlink sub-bands; else if the frequency domain resource assignment is for the non-sub-band full duplex, apply as a reference point of physical resource blocks for the frequency domain resource assignment, a second physical resource block of the contiguous downlink band that is different from the first physical resource block; and determine physical resource blocks of the frequency domain resource assignment by using the applied reference point and receive data in the determined physical resource blocks.

In some embodiments, the computer readable medium may include instructions that, when executed by the apparatus, may cause the terminal device to: perform wrap-around to a second downlink sub-band of the non-contiguous downlink sub-bands for the determined physical resource blocks in a case where, starting from the first physical resource block, the determined physical resource blocks exceed the first downlink sub-band.

In some embodiments, the computer readable medium may include instructions that, when executed by the apparatus, may cause the terminal device to: in a case where a bandwidth part is configured for the terminal device and the bandwidth part at least partly comprises the non-contiguous downlink sub-bands, perform the wrap-around for the determined physical resource blocks if, starting from the first physical resource block, the determined physical resource blocks exceed the bandwidth part.

In some embodiments, the computer readable medium may include instructions that, when executed by the apparatus, may cause the terminal device to: map indices of the determined physical resource blocks to corresponding indices in the non-contiguous downlink sub-bands.

In some embodiments, the first downlink sub-band may be the upper downlink sub-band of the non-contiguous downlink sub-bands.

In some embodiments, the first physical resource block may be the physical resource block with the smallest index in the first downlink sub-band.

In some embodiments, the first physical resource block may be applied as the reference point according to a reference point configuration received from the network device.

In some embodiments, the first physical resource block may be applied as the reference point in case of receiving from the network device an indication allowing the terminal device to apply as the reference point the first physical resource block.

In some embodiments, the terminal device may be configured with at least one of the following: channel status information reference signal, control resource set, frequency domain resource assignment type 0, or frequency domain resource assignment type 1.

The example embodiments of the present disclosure also provide a computer readable medium comprising program instructions that, when executed by an apparatus for a network device such as the network device 130 in the above examples, may cause the network device at least to: transmit to a terminal device served by the network device, a configuration of sub-band full duplex comprising non-contiguous downlink sub-bands, a configuration of a non-sub-band full duplex comprising a contiguous downlink band, and a frequency domain resource assignment for downlink; determine whether the frequency domain resource assignment is for the sub-band full duplex or for the non-sub-band full duplex; if the frequency domain resource assignment is for the sub-band full duplex, apply as a reference point of physical resource blocks for the frequency domain resource assignment, a first physical resource block of a first downlink sub-band of the non-contiguous downlink sub-bands; else if the frequency domain resource assignment is for the non-sub-band full duplex, apply as a reference point of physical resource blocks for the frequency domain resource assignment, a second physical resource block of the contiguous downlink band that is different from the first physical resource block; and determine physical resource blocks of the frequency domain resource assignment by using the applied reference point and transmit data in the determined physical resource blocks.

In some embodiments, the computer readable medium may include instructions that, when executed by the apparatus, may cause the network device to: perform wrap-around to a second downlink sub-band of the non-contiguous downlink sub-bands for the determined physical resource blocks in a case where, starting from the first physical resource block, the determined physical resource blocks exceed the first downlink sub-band.

In some embodiments, the computer readable medium may include instructions that, when executed by the apparatus, may cause the network device to: in a case where a bandwidth part is configured for the terminal device and the bandwidth part at least partly comprises the non-contiguous downlink sub-bands, perform the wrap-around for the determined physical resource blocks if, starting from the first physical resource block, the determined physical resource blocks exceed the bandwidth part.

In some embodiments, the computer readable medium may include instructions that, when executed by the apparatus, may cause the network device to: map indices of the determined physical resource blocks to corresponding indices in the non-contiguous downlink sub-bands.

In some embodiments, the first downlink sub-band may be the upper downlink sub-band of the non-contiguous downlink sub-bands.

In some embodiments, the first physical resource block may be the physical resource block with the smallest index in the first downlink sub-band.

In some embodiments, the computer readable medium may include instructions that, when executed by the apparatus, may cause the network device to: transmit to the terminal device, a reference point configuration, according to which the first physical resource block is applied as the reference point.

In some embodiments, the computer readable medium may include instructions that, when executed by the apparatus, may cause the network device to: transmit to the terminal device, an indication allowing the terminal device to apply as the reference point the first physical resource block.

In some embodiments, the computer readable medium may include instructions that, when executed by the apparatus, may cause the network device to: configure for the terminal device at least one of the following: channel status information reference signal, control resource set, frequency domain resource assignment type 0, or frequency domain resource assignment type 1.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP 3rd Generation Partnership Project
BWP bandwidth part
CORESET control resource set
CRB common resource block
CSI-RS channel status information reference signal
DL downlink
DUD downlink uplink downlink
FDRA frequency domain resource assignment or allocation
FDU full or flexible division duplexing
NR new radio
PRB physical resource blocks
RB resource block
RBG resource block group
RIV resource indication value
SBFD sub-band full duplex
TBS transport block size
UE user equipment
UL uplink
xDD cross division duplexing

1. An apparatus for a terminal device, comprising:
at least one processor; and
at least one memory storing instructions that, when executed by the at least one processor, cause the terminal device at least to:
receive from a network device serving the terminal device, a configuration of sub-band full duplex comprising non-contiguous downlink sub-bands, a configuration of a non-sub-band full duplex comprising a contiguous downlink band, and a frequency domain resource assignment for downlink;
determine whether the frequency domain resource assignment is for the sub-band full duplex or for the non-sub-band full duplex;
if the frequency domain resource assignment is for the sub-band full duplex, apply as a reference point of physical resource blocks for the frequency domain resource assignment, a first physical resource block of a first downlink sub-band of the non-contiguous downlink sub-bands;
else if the frequency domain resource assignment is for the non-sub-band full duplex, apply as a reference point of physical resource blocks for the frequency domain resource assignment, a second physical resource block of the contiguous downlink band that is different from the first physical resource block; and
determine physical resource blocks of the frequency domain resource assignment by using the applied reference point and receive data in the determined physical resource blocks.

2. The apparatus of claim 1, wherein the apparatus is configured to:
perform wrap-around to a second downlink sub-band of the non-contiguous downlink sub-bands for the determined physical resource blocks in a case where, starting from the first physical resource block, the determined physical resource blocks exceed the first downlink sub-band.

3. The apparatus of claim 2, wherein the apparatus is configured to:
in a case where a bandwidth part is configured for the terminal device and the bandwidth part at least partly comprises the non-contiguous downlink sub-bands, perform the wrap-around for the determined physical resource blocks if, starting from the first physical resource block, the determined physical resource blocks exceed the bandwidth part.

4. The apparatus of claim 1, wherein the apparatus is configured to:
map indices of the determined physical resource blocks to corresponding indices in the non-contiguous downlink sub-bands.

5. The apparatus of claim 1, wherein the first downlink sub-band is the upper downlink sub-band of the non-contiguous downlink sub-bands.

6. The apparatus of claim 1, wherein the first physical resource block is the physical resource block with the smallest index in the first downlink sub-band.

7. The apparatus of claim 1, wherein the first physical resource block is applied as the reference point according to a reference point configuration received from the network device.

8. The apparatus of claim 1, wherein the first physical resource block is applied as the reference point in case of receiving from the network device an indication allowing the terminal device to apply as the reference point the first physical resource block.

9. The apparatus of claim 1, wherein the terminal device is configured with at least one of the following:
channel status information reference signal,
control resource set,
frequency domain resource assignment type 0, or
frequency domain resource assignment type 1.

10. An apparatus for a network device, comprising:
at least one processor; and
at least one memory storing instructions that, when executed by the at least one processor, cause the network device at least to:
transmitting to a terminal device served by the network device, a configuration of sub-band full duplex comprising non-contiguous downlink sub-bands, a configuration of a non-sub-band full duplex comprising a contiguous downlink band, and a frequency domain resource assignment for downlink;
determine whether the frequency domain resource assignment is for the sub-band full duplex or for the non-sub-band full duplex;
if the frequency domain resource assignment is for the sub-band full duplex, apply as a reference point of physical resource blocks for the frequency domain resource assignment, a first physical resource block of a first downlink sub-band of the non-contiguous downlink sub-bands;
else if the frequency domain resource assignment is for the non-sub-band full duplex, apply as a reference point of physical resource blocks for the frequency domain resource assignment, a second physical resource block of the contiguous downlink band that is different from the first physical resource block; and
determine physical resource blocks of the frequency domain resource assignment by using the applied reference point and transmit data in the determined physical resource blocks.

11-15. (canceled)

16. The apparatus of claim 10, wherein the apparatus is configured to:
transmit to the terminal device, a reference point configuration, according to which the first physical resource block is applied as the reference point

17-18. (canceled)

19. A method performed by an apparatus for a terminal device, comprising:
receiving from a network device serving the terminal device, a configuration of sub-band full duplex comprising non-contiguous downlink sub-bands, a configuration of a non-sub-band full duplex comprising a contiguous downlink band, and a frequency domain resource assignment for downlink;
determining whether the frequency domain resource assignment is for the sub-band full duplex or for the non-sub-band full duplex;
if the frequency domain resource assignment is for the sub-band full duplex, applying as a reference point of physical resource blocks for the frequency domain resource assignment, a first physical resource block of a first downlink sub-band of the non-contiguous downlink sub-bands;
else if the frequency domain resource assignment is for the non-sub-band full duplex, applying as a reference point of physical resource blocks for the frequency domain resource assignment, a second physical resource block of the contiguous downlink band that is different from the first physical resource block; and
determining physical resource blocks of the frequency domain resource assignment by using the applied reference point and receiving data in the determined physical resource blocks.

20. The method of claim 19, comprising:
performing wrap-around to a second downlink sub-band of the non-contiguous downlink sub-bands for the determined physical resource blocks in a case where, starting from the first physical resource block, the determined physical resource blocks exceed the first downlink sub-band.

21. The method of claim 20, comprising:
in a case where a bandwidth part is configured for the terminal device and the bandwidth part at least partly comprises the non-contiguous downlink sub-bands, performing the wrap-around for the determined physical resource blocks if, starting from the first physical resource block, the determined physical resource blocks exceed the bandwidth part.

22. The method of claim 19, comprising:
mapping indices of the determined physical resource blocks to corresponding indices in the non-contiguous downlink sub-bands.

23. The method of claim 19, wherein the first downlink sub-band is the upper downlink sub-band of the non-contiguous downlink sub-bands.

24. The method of claim 19, wherein the first physical resource block is the physical resource block with the smallest index in the first downlink sub-band.

25. The method of claim 19, wherein the first physical resource block is applied as the reference point according to a reference point configuration received from the network device.

26. The method of claim 19, wherein the first physical resource block is applied as the reference point in case of receiving from the network device an indication allowing the terminal device to apply as the reference point the first physical resource block.

27. The method of claim 19, wherein the terminal device is configured with at least one of the following:
channel status information reference signal,
control resource set,
frequency domain resource assignment type 0, or
frequency domain resource assignment type 1.

28-40. (canceled)
